(19) United States
(12) Patent Application Publication
(10) Pub. No.: US 2008/0105724 A1
(43) Pub. Date: May 8, 2008

(54) Nailer having nail suspending device

(75) Inventors: Jae Sung Kim, Seoul (KR); Sang Chun Lee, Seongnam-si (KR)

Correspondence Address: GWIPS;Peter T. Kwon, Gwacheon P.O. Box 72, 119 Byeolyang Ro, Gwacheon City, Gyeonggi-Do, 427-600, KR

(73) Assignee: Jeil Tacker Co., Ltd.

(21) Appl. No.: 12/003,799

(22) Filed: Jan. 2, 2008

Related U.S. Application Data
(63) Continuation-in-part of application No. 11/255,407, filed on Oct. 20, 2005, now abandoned.

(30) Foreign Application Priority Data
Apr. 20, 2005 (KR) 20-2005-10997

(51) Int. Cl. B25C 1/00

(52) U.S. Cl. 227/113; 227/107

(57) ABSTRACT

A nailing tool having a nail suspender is developed for holding a last nail which is supplied into an ejection guide. The suspender can activate in response to the movement of a connecting unit to repeatedly perform the holding and releasing the last nail to prevent from free releasing, which is supplied into the ejection guide for firing. The contactor and connecting unit are mounted along the muzzle guide. When the contactor is pressed against on a target site, the connecting unit activates the suspender to hold the nail in the firing standby unit to prevent the last nail from free dropping before firing. A magnetic member is attached to the lower end of the suspender to securely hold the nail, so that the nail can be prevented from free dropping.

This is a Continuation In Part (CIP) of Ser. No. 11/255,407, filed Oct. 20, 2005, now pending patent application.

### BACKGROUND OF THE INVENTION

1. Field of the Invention

The present invention relates to a nailing tool equipped with a nail suspending device, and more particularly to a nailing tool including a nail suspender formed at the upper end of an ejection guide for holding the last nail in the central region of the slot to prevent dropping of the last nail that is supplied for firing.

2. Related Prior Art

As well known to those skilled in the art, a tacker-nailer, a stapler, and a pinner, which are used in constructing a building and the interior parts of the building, are pneumatic tools used to fasten two pieces of lumber, lumber to a plastic article, a wooden article to a steel article, or a wooden article to a concrete article, in various applications, such as interior and exterior construction projects and assembling of aluminum chassis.

General operational principles of a tacker, a nailer, a stapler, and a pinner are substantially identical to each other, but their structures are slightly different from each other.

FIG. 1 is a perspective view illustrating the external appearance of a conventional nailer, and FIG. 2 is an enlarged view illustrating a main part of a front standby unit of the conventional nailer.

Referring to the drawings, the external appearance of the conventional nailer 1, as illustrated in FIG. 1, includes a body 104 having a piston and a cylinder installed therein, a handgrip provided in the lower end of the body 104 to be grasped by a hand and having an air passage through which air is supplied to the piston, a magazine 110 provided in the front end of the body 104 containing nails, staples, and pins therein, and a firing standby unit 112 to receive and arrange the nails, staples, or pins that are loaded in the magazine 110 on standby for firing inside a front muzzle.

Moreover, a door unit 130 is provided in the lower side of the firing standby unit 112 of the body 104 to allow the user to check the feeding status of the nails, the staples, or the pins fed from the magazine 110, and includes a door 132 to be opened in the vertical direction and a door latch 134 provided in the lower end of the door 132 to perform a locking function when the door 132 is opened and closed.

A hinge shaft 136 is coupled with a lateral side of the front firing standby unit 112 of the body 104 to open and close the door 132. The muzzle 114 constituting the front end of the firing standby unit 112 that is connected to the front end of the body 104, has an outer circumference which is surrounded by a muzzle guide 115, and the muzzle guide 115 is coupled with a contactor connector 113, the lower end of which is bent and coupled with a contactor 100 (See FIG. 3) to go in and out of the front end of a trigger (not shown).

FIG. 3 is a side sectional view illustrating the firing of the conventional nailer, and FIG. 4 is a plan sectional view illustrating a main part of a guide of the conventional nailer.

Referring to the drawings, a single shot mode and a quick fire mode using the conventional tacker will be described. The tacker includes a safety device provided in the front end thereof and connected to the contactor 100. The contactor 100 contacts a pushing plate 94 as illustrated in FIG. 3 so that the movement of an actuator 10 caused by a trigger 92 is restricted.

The safety device is configured such that the firing is not performed unless the contactor 100 moves to the rear end of the tacker during the single shot or the quick firing, and thereby accidents caused by user carelessness can be prevented.

In other words, in the conventional nailer 1, the outer circumference is surrounded by the muzzle guide 115, and the muzzle guide 115 is coupled with the contactor 100 to go in and out of the front end of the trigger 92 through the contactor connector 113.

In this case, since the muzzle guide 115 protrudes forward farther than the front end of the muzzle 114 by about 1 cm, the muzzle guide 115 is pushed back by 1 cm when the muzzle guide 115 contacts a target position of an object and the nailer 1 is pressed to bring the muzzle 114 into contact with the target position. Due to this, the contactor 100 is pushed back as well because the muzzle guide 115 is connected to the contactor 100 through the contactor connector 113.

In more detail, when a user puts the nailer 1 into contact with the target position of the object and presses the nailer 1 during the single shot or the quick firing process using the conventional nailer 1, the contactor 100 moves toward the actuator 10. Then, the rear end of the contactor 100 moves the pushing plate 94 (which is coupled with the inner lower end of the trigger 92 by a coupling pin 96) toward the actuator 10 by a predetermined distance.

Thereby, due to the retreat of the pushing plate 94, the rear side of the pushing plate 94 depresses a valve rod 12, which is protruding from the actuator 10, into the actuator 10, by a predetermined distance.

In this state, when the user pulls the trigger 92, the lower end of the trigger 92 pivots about a pivot pin 97 coupled with the upper end of the trigger 92. Then, a rear contact surface 94b of the pushing plate 94, which is connected to the trigger 92 by the coupling pin 96, completely depresses the valve rod 12 into the actuator 10. When the valve rod 12 is completely inserted into the actuator 10, tacker pins or nails loaded in the magazine 110 are fired forward.

At that time, although the pushing plate 94 is coupled with the lower end of the trigger 92 by the coupling pin 96, since the pushing plate 94 cannot depress the valve rod 12 into the actuator 10 completely, the tacker pin or the nail cannot be fired. Thus, when the trigger 92 is pulled under the condition that a contact point of the pushing plate 94 against the contactor 100 becomes a supporting point, the upper end of the pushing plate 94 cannot move forward due to the contact with the contactor 100, and the lower end of the pushing plate 94 moves due to the pivoting of the trigger 92 to fully depress the valve rod 12.

The quick firing of the conventional nailer 1 is a function of the user firing not a single nail 2 but several nails 2 to the broad target site of an object over a short time. In the quick firing mode, the user pulls and holds the trigger 92 and presses the front end of the tacker to the target site of the object so that the contactor 100 retreats toward the actuator 10 to fire. The basic principle of the quick firing mode is the same as that of the single shot. However, in the quick firing mode, the muzzle 114 does not contact the object first, but the trigger 92 is pulled first and in this state, the muzzle 114 is pressed onto the target site of the object so that the firing is performed.

In a case where a single nail 2 is pushed up from the magazine 110 and stands by in a guide 200 (See FIG. 4) for firing and the front end of the muzzle guide 115 (See FIG. 1) of the nailer 1 contacts a floor or the upper side of a roof, the single nail 2 may separate from the guide 200 of the nailer 1 and drop through the muzzle 114. The guide 200 is tube located inside of the firing standby unit 112.

### SUMMARY OF THE INVENTION

Therefore, the present invention has been made in view of the above problems, and it is an aspect of the present invention to provide a nailer with a nail suspender in which a slot is formed in an upper end of a guide, the suspender is coupled in the central region of the slot to rotate in response to the movement of a connector such that it can prevent the dropping of a final remaining nail that is in a standby position for firing.

In accordance with the present invention, the above and other aspects can be accomplished by the provision of a nailer with a nail suspender comprising a muzzle guide surrounding the front end of a muzzle, one end connected to the muzzle guide, and the opposite end connected to a contactor, and coupled to a lateral side of a firing standby unit to contact the firing standby unit to control the firing of a nail, the nailer comprising: a slot of a predetermined length formed at a predetermined position on an inner circumference of a guide of the firing standby unit; brackets protruding from the upper and lower sides of the firing standby unit in which the slot is formed; a rotating suspender coupled with a rotation shaft in the brackets to release the nail only when a contactor connector moves backward; and a torsion spring disposed between the brackets and the suspender to apply a tensile force such that the suspender remains perpendicular to the guide.

Preferably, the suspender has a triangular shape and stops the nail such that the nail is prevented from dropping when the muzzle of the nailer faces the ground.

Further, the suspender comprises a coupler partially extending from the lower end of the suspender; and a magnetic member coupled with the coupler to attach the nail thereto.

The magnetic member has a round lower side such that the magnetic member is securely attached to the outer circumference of the nail.

### BRIEF DESCRIPTION OF THE DRAWINGS

FIG. 1 is a perspective view illustrating an external appearance of a conventional nailer.

FIG. 2 is an enlarged perspective view illustrating a main part of a front standby unit of the conventional nailer.

FIG. 3 is a side sectional view illustrating the firing of the conventional nailer.

FIG. 4 is a plan sectional view illustrating a main part of a guide of the conventional nailer.

FIG. 5 is an enlarged perspective view illustrating an open state of a door unit provided in a nailer with a nail suspender according to an embodiment of the present invention.

FIG. 6 is a plan view illustrating the nailer with a nail suspender according to the embodiment of the present invention.

FIG. 7 is a front view illustrating an open state of a door of the nailer with a nail suspender according to the embodiment of the present invention.

FIGS. 8A and 8B are views illustrating the operation of a contactor connector of the nailer with a nail suspender according to the embodiment of the present invention.

FIGS. 9A and 9B are views illustrating a suspender of the nailer with a nail suspender according to the embodiment of the present invention.

FIGS. 10A, 10B, and 10C are side sectional views illustrating the operation of the suspender of the nailer with a nail suspender according to the embodiment of the present invention.

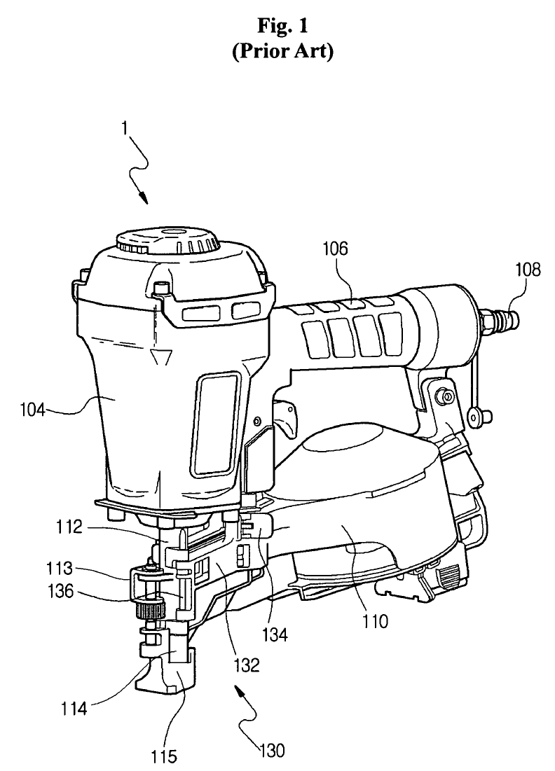

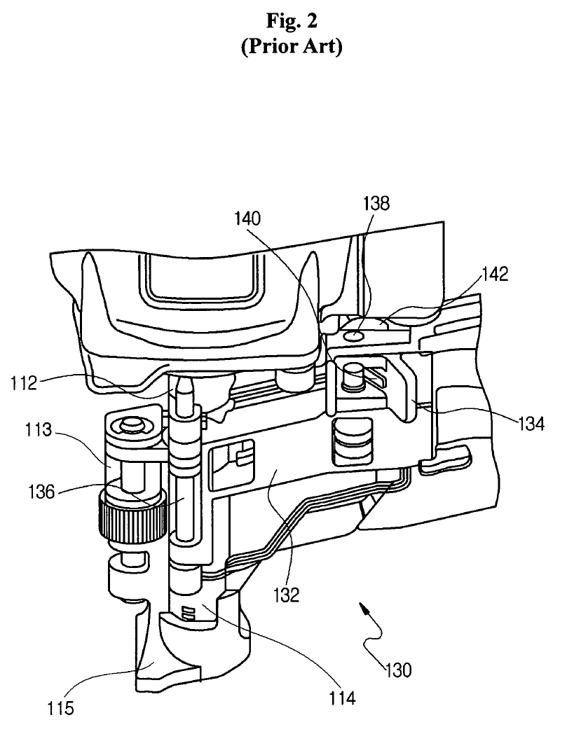

### DETAILED DESCRIPTION OF THE PREFERRED EMBODIMENTS

Hereinafter, a nailing machine tool equipped with a nail suspender of the present invention will be described in detail with reference to the accompanying drawings.

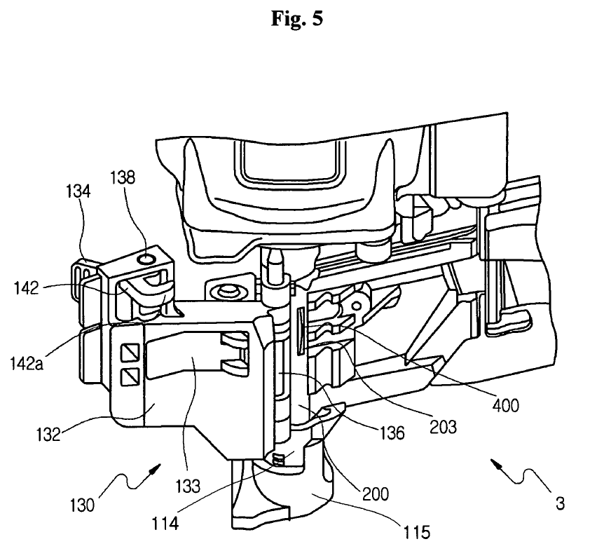

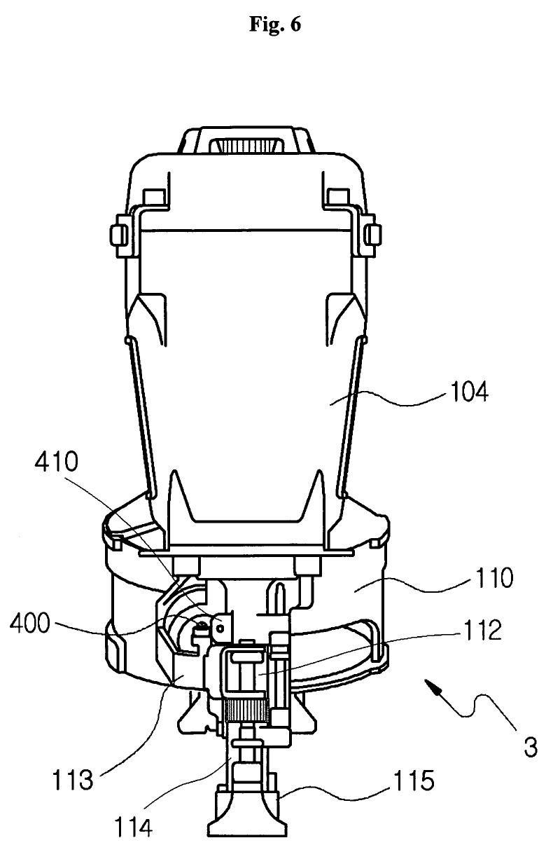

FIG. 5 is an enlarged perspective view illustrating an open state of a door unit provided in a nailer with a nail suspender according to an embodiment of the present invention, and FIG. 6 is a plan view illustrating the nailer with a nail suspender according to the embodiment of the present invention.

Referring to the figures, the nailer equipped with a nail suspender according to the embodiment of the present invention includes an ejecting guide with a slot formed at the upper end thereof, a suspender installed on a bracket to rotate through the center of the slot, so that the suspender performs holding and releasing operations in response to the movement of a contactor in order to prevent the dropping of the last nail in the firing standby unit.

In the nailer 3 with a nail suspender according to the embodiment of the present invention, a door unit 130 includes a door 132 to be opened and closed vertically, a door latch 134 is installed to be manipulated in the vertical direction, and a hinge shaft 138 of the door latch 134 can serve also as a hinge shaft of a check pawl 133 formed in the central region of the door 132. Thus, the number of components can be reduced.

When the lower side of the door latch 134 is pressed upward, a hook 142 formed in the opposite end of the door latch 134 is released from a locking protrusion (not shown). When the door latch 134 is continuously pressed in the direction that opens the door latch 134, the door 132 is opened.

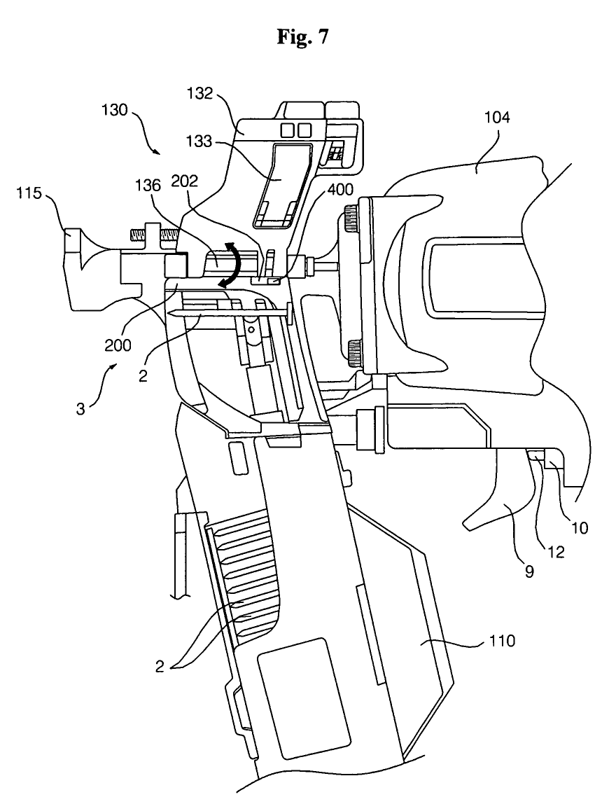

As shown in FIG. 7, a nail 2 is in a standby position for loading into the firing standby unit 112. The nail suspender according to the embodiment of the present invention is holding the nail in the tube of the guide 200.

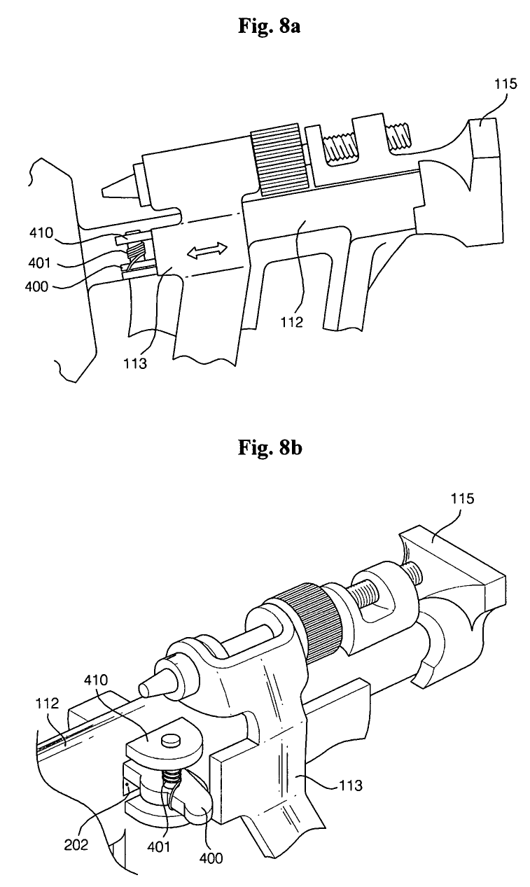

As illustrated in FIGS. 8A and 8B, in the nailer 3 with a nail suspender according to the embodiment of the present invention, a slot 202 of a predetermined length is formed in the longitudinal direction on the circumference of the guide 200, and a bracket 410 is formed from the upper and lower sides of the outer circumference of the firing standby unit 112 in which the slot 202 is formed.

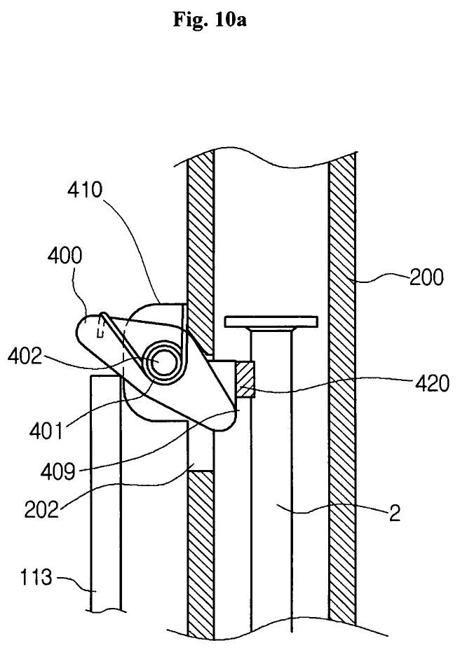

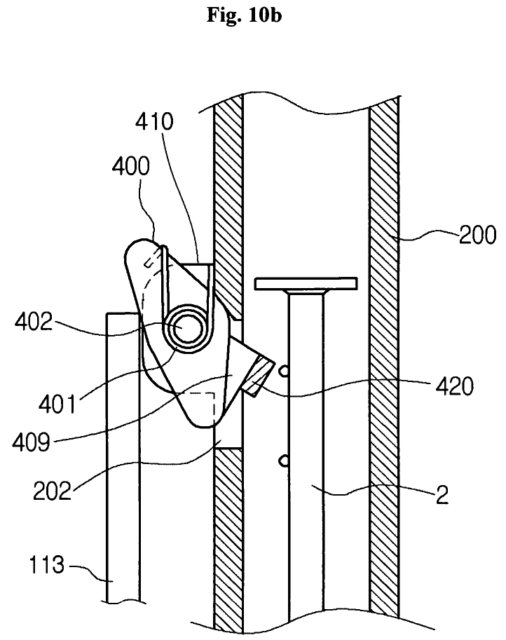

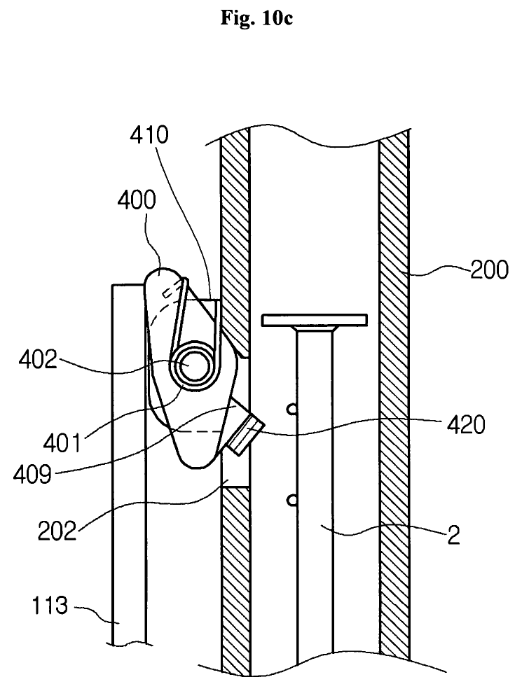

The suspender 400 is installed on the bracket 410. The rotating suspender 400 is coupled by a rotation shaft 402 (See FIG. 10A) and a torsion spring 401 is disposed between the bracket 410 and the suspender 400 so that a tensile force from the torsion spring 401 is applied to maintain the suspender 400 perpendicular to the guide 200.

As illustrated in FIG. 8B, a connecting unit 210 is composed of a contactor 115, a connecting length adjuster 116, an activating bracket 113 and a connecting length adjusting knob 117. When the contactor 115 presses down on a work piece, the control bracket 113 connected to the connecting unit 210 moves backward along the muzzle guide 114. The activating bracket 113 pushes the suspender 400 and the suspender 400 rotates about the rotation shaft 402, so that the nail 2 is released. Thus, the suspender 400 performs the holding and releasing of the nail 2.

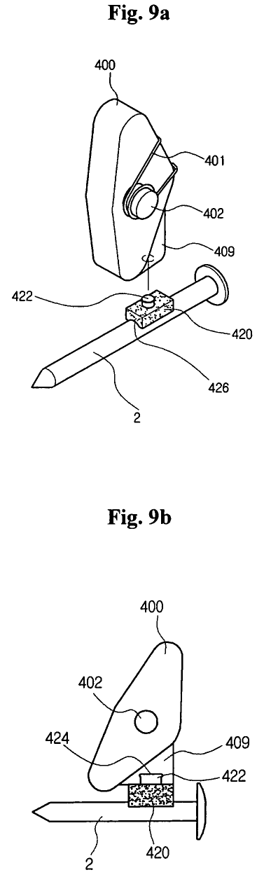

FIGS. 9A and 9B are views illustrating a suspender of the nailer with a nail suspender according to the embodiment of the present invention.

Referring to the drawing, preferably, the nailer 3 with a nail suspender according to the embodiment of the present invention is configured such that a coupler 409 is partially extended from the lower end of the suspender 400 and a magnetic member 420 is coupled with the coupler 409.

The magnetic member 420 is a magnetic body made of a rubber magnet and includes a coupling protrusion 422 formed in the upper side thereof to be coupled with the coupler 409. The coupler 409 has an insertion hole 424 formed in the lower side thereof into which the coupling protrusion is inserted with a press fit.

The nailer 3 with a nail suspender according to the embodiment of the present invention sufficiently prevents the nail 2 from dropping using only the suspender 400 provided therein, but for the more robust prevention of the nail 2 from dropping, the magnetic member 420 is combined with the suspender 400 in the above-mentioned structure.

Preferably, the magnetic member 420 has a round lower side 426 such that the round lower side can be firmly attached to the outer circumference of the nail 2 when the magnetic member 420 is attached to the nail 2.

Function and operation of the nailer with a nail suspender according to the embodiment of the present invention will be described in detail with reference to the accompanying drawings.

FIGS. 10A, 10B, and 10C are side sectional views illustrating the operation of the suspender of the nailer with a nail suspender according to the embodiment of the present invention.

Referring to the drawings, in the nailer 3 with a nail suspender according to the embodiment of the present invention, as the muzzle guide 115 retreats, the contactor connector 113 connected to the muzzle guide 115 pushes the suspender 400 toward the rear side of the nailer 3 in the order of FIGS. 10A, 10B, and 10C.

If the user pulls the trigger for quick firing, as illustrated in FIG. 10A, the suspender 400 remains perpendicular to the guide 200 due to the torsion springs 401 respectively disposed at the suspender 400 and the bracket 410.

Especially, since the magnetic member 420 is provided on the suspender 400, the nail 2 is attached to the suspender 420 by the magnetic member 420. Thus, the nail 2 can be prevented from dropping without fail.

In this state, when the user brings the muzzle guide 115 into contact with the target side of an object and presses the nailer 3 against the target site while pulling the trigger, the muzzle guide 115 moves backward, the contactor connector 113 connected to the muzzle guide 115, as illustrated in FIGS. 10B and 10C, pushes one end of the suspender 400 backward, and the magnetic member 420 provided on the opposite end of the suspender 400 is detached from the nail 2.

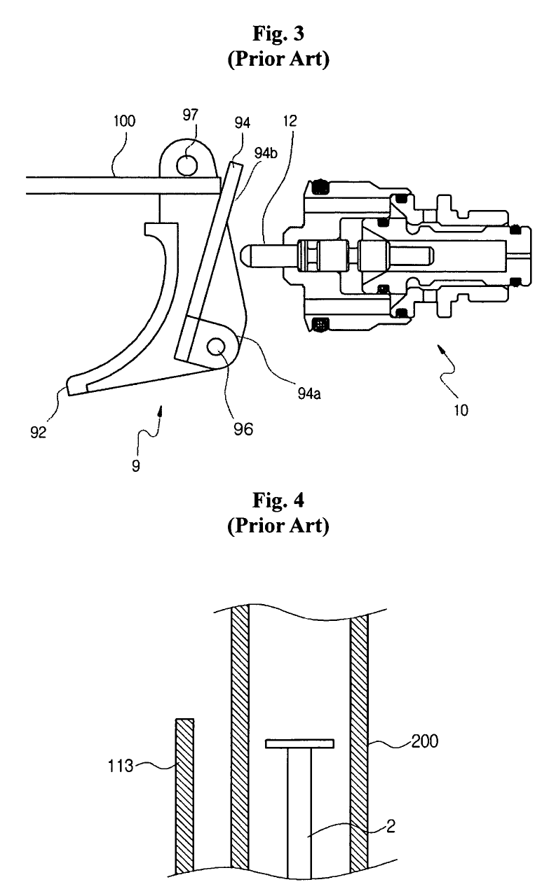

Then, the contactor 100 connected to the contactor connector 113, as illustrated in FIG. 3, pushes a pushing plate 94 backward so that an actuator 10 is actuated to strike the nail 2.

In this state, if the trigger is held down and the muzzle guide 115 is separated from the target site, the muzzle guide 115 moves forward and the contactor connector 113 connected to the muzzle guide 115, as illustrated in FIG. 10A, releases the suspender 400, and the suspender 400 is kept perpendicular to the guide 200 by the torsion springs 401 provided on the suspender 400 and the bracket 410.

At that time, for the next firing, the nail 2 loaded in the guide 200 is attached to the magnetic member 420 of the suspender so that the nail 2 is prevented from dropping.

According to the nailer with a nail suspender of the present invention, the contactor connector connected to the muzzle guide that moves backward manipulates the suspender provided in the guide of the firing standby unit when the muzzle contacts the target site of an object, so that the nail is prevented from dropping before firing. The magnetic member is attached to a lower side of the suspender so that the nail can be securely attached thereto.

The nailer with a nail suspender according to the embodiment of the present invention is not limited to the above-mentioned embodiment, but can be made with various modifications and changes within the scope of the present invention without departing from the scope of the present invention.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A nailing machine equipped with a nail suspender having a muzzle guide surrounding the front end of a muzzle, one end connected to the muzzle guide, the opposite end connected to a contactor, a firing standby unit and a nail firing control unit, the nailing machine comprising:
a firing standby unit (112) with a slot (202) formed at a predetermined position on an ejecting guide,
a bracket (410) protruding from the firing standby unit (112) in which the slot is formed,
a suspender installed on a rotation shaft (402) on the bracket (410) to control the nail when a contactor connector moves backward,
a torsion spring installed on the rotation shaft (402) for exerting resilient force on the suspender, and
a connecting unit (210) for activating the nail suspender (400), said connecting unit (210) having a contactor (115), a connecting length adjuster (116), an activating bracket (113) and a connecting length adjusting knob (117) for adjusting an activating length thereof.

2. The nailing machine according to claim 1, wherein said suspender forms a triangular shape for holding the nail in the muzzle guide, so that the last nail supplied to the muzzle guide is prevented from dropping when the muzzle faces the ground.

3. The nailing machine according to claim 1, wherein the suspender comprises:
a coupler partially extending from the lower end of the suspender, and
a magnetic member coupled with the coupler to attach the nail thereto.

4. The nailing machine according to claim 3, wherein said magnetic member has a round lower side so that said magnetic member is secured to hold the last nail.
